(19) United States
(12) Patent Application Publication
(10) Pub. No.: US 2004/0193835 A1
(43) Pub. Date: Sep. 30, 2004

(54) Table lookup instruction for processors using tables in local memory

(76) Inventors: Patrick Devaney, Haverhill, MA (US); David M. Keaton, Boulder, CO (US); Katsumi Murai, Moriguchi-City (JP)

Correspondence Address: RATNERPRESTIA, P O BOX 980, VALLEY FORGE, PA, 19482-0980, US

(21) Appl. No.: 10/403,209

(22) Filed: Mar. 31, 2003

(51) Int. Cl. G06F 12/00

(52) U.S. Cl. 711/220

(57) ABSTRACT

In a processor system configured to execute instructions, a method finds an entry in at least one table stored in memory. The method includes (a) storing a first table of multiple entries, each entry including a bit field; (b) storing (i) a first entry of the first table and (ii) a bit size of each entry; (c) storing a sequence of data bits; (d) selecting a portion of the sequence of data bits to produce a data field having a bit size same as the bit size of each entry in the first table; and (e) adding the first entry of the first table to the produced data field to find the entry in the first table.

### FIELD OF THE INVENTION

The present invention relates, in general, to a method for accessing a level-one local memory and, more specifically, to a method of accessing multi-level lookup tables in a level-one local memory using a custom instruction.

### BACKGROUND OF THE INVENTION

MPEG-2 (Motion Picture Experts Group-2), for example, is a popular format for digital video production used in the broadcasting industry. In this format, a transform, such as a two-dimensional discrete cosine transform (DCT) is applied to blocks (e.g., four 8×8 blocks per macroblock) of image data (either the pixels themselves or interframe pixel differences corresponding to those pixels). The resulting transform coefficients are then quantized at a selected quantization level where many of the coefficients are typically quantized to a zero value.

In general, most of the transform coefficients are frequently quantized to zero. There may be a few non-zero low-frequency coefficients and a sparse scattering of non-zero high-frequency coefficients, but the great majority of coefficients are quantized to zero. To exploit this phenomenon, the two-dimensional array of transform coefficients is reformatted and prioritized into a one-dimensional sequence, through either a zigzag or alternate scanning process. This results in most of the important non-zero coefficients (in terms of energy and visual perception) being grouped together early in the sequence. These non-zero coefficients are followed by long runs of coefficients that are quantized to zero. These zero-valued coefficients may be efficiently represented through run-length encoding.

In run-length encoding, the number (run) of consecutive zero coefficients before a non-zero coefficient is encoded, followed by the non-zero coefficient value (amplitude). As a result of the scanning process, most of the zero and non-zero coefficients are separated into groups, thereby enhancing the efficiency of the run-length encoding. Also, a special end-of-block (EOB) marker is used to signify when all of the remaining coefficients in the sequence are equal to zero. This approach is extremely efficient, and yields a significant degree of compression.

An example of run length encoding is shown in Table 1. Each variable length code entry in the table represents a set of (run, amplitude and sign (+, −)). It will be appreciated that only a small portion of the code is included in the table. Most of the code is omitted.

TABLE 1
An example of run length encoding
(many variable length codes not shown).

| Variable length code (NOTE) | | run | amplitude |
|---|---|---|---|
| 10 | | End of Block (EOB) | |
| 011 | s | 1 | 1 |
| 0100 | s | 0 | 2 |
| 0101 | s | 2 | 1 |
| 0010 1 | s | 0 | 3 |
| 0011 1 | s | 3 | 1 |
| 0011 0 | s | 4 | 1 |
| 0001 10 | s | 1 | 2 |
| 0001 11 | s | 5 | 1 |
| 0001 01 | s | 6 | 1 |
| 0001 00 | s | 7 | 1 |
| 0000 110 | s | 0 | 4 |
| 0000 100 | s | 2 | 2 |
| 0000 111 | s | 8 | 1 |
| 0000 101 | s | 9 | 1 |
| 0000 01 | | Escape | |
| 0010 0110 | s | 0 | 5 |
| 0010 0001 | s | 0 | 6 |
| 0010 0111 | s | 10 | 1 |
| 0010 0011 | s | 11 | 1 |
| 0010 0010 | s | 12 | 1 |
| 0010 0000 | s | 13 | 1 |
| 0000 0010 10 | s | 0 | 7 |

NOTE
The last bit ‘s’ denotes the sign of the amplitude,
‘0’ for positive
‘1’ for negative.

At the decoder, an inverse transformation is applied to recover the original image. In MPEG-2, it is necessary to decode one variable length code-word per pixel for periods of up to one frametime. An HDTV frame contains 1920 ×1080=2.0736 Mpix; so the pixel rate is 30×2.0736=62.208 Mpix/s. At a CPU clock of 450 Mhz, 7.23 clocks are available per HDTV pixel. Rounding down, a new decoded pixel must be produced every seven clocks. (For a 20 Mbps datastream, for example, one bit arrives every 22.5 CPU clocks. Therefore, the majority of the bits to be decoded must come from a video buffer.)

### SUMMARY OF THE INVENTION

To meet this and other needs, and in view of its purposes, the present invention provides a method of finding an entry in at least one table stored in memory. The method includes the steps of: (a) storing a first table of multiple entries, each entry including a bit field; (b) storing (i) a first entry of the first table and (ii) a bit size of each entry; (c) storing a sequence of data bits; (d) selecting a portion of the sequence of data bits to produce a data field having a bit size same as the bit size of each entry in the first table; and (e) adding the first entry of the first table to the produced data field to find the entry in the first table.

In another embodiment, the invention provides a method for decoding a portion of a stream of bits. The method includes (a) receiving a stream of bits; (b) storing at least one table having multiple entries, each entry including a bit field and a corresponding result; (c) storing (i) a first entry of the table and (ii) a bit size of each entry; (d) selecting a portion of the received stream of bits to produce a data field having a bit size the same as the bit size of each entry in the table; (e) adding the first entry of the table to the produced data field to find the entry in the table; (f) finding the entry in the table; (g) fetching from the table a result corresponding to the entry found in step (f); and (h) if the result is a decoded word of the selected portion of the received stream of bits, then storing the decoded word in a destination register.

Step (h) may further include setting a flag to indicate that the result is the decoded word; and the method further includes the steps of: (i) storing the flag, the first entry of the table and the bit size of each entry in a register to produce a first operand, accessed by a computer instruction; (j) storing the data field in another register to produce a second operand, accessed by the same computer instruction; and (k) using the same computer instruction to store the decoded word as a destination operand in the destination register.

In a further embodiment, the invention provides a computer instruction for accessing a look-up-table (LUT). Each LUT includes an entry word defining a location in the LUT, and a result word corresponding to the entry word. The computer instruction includes an opcode for instructing a processor to access an entry word in an LUT. A first operand is provided for use by the opcode, in which the first operand includes a first entry word in the LUT. A second operand is provided for use by the opcode, in which the second operand includes an entry word located in the LUT. A destination operand is also provided for use by the opcode for storing a result word. In response to the opcode, the processor is configured to add the first entry word of the first operand and the entry word of the second operand to locate the entry word in the LUT, and the processor is configured to fetch the result word corresponding to the located entry word and store the result word in memory.

It is understood that the foregoing general description and the following detailed description are exemplary, but are not restrictive, of the invention.

### BRIEF DESCRIPTION OF THE DRAWINGS

The invention is best understood from the following detailed description when read in connection with the accompanying drawing. Included in the drawing are the following figures:

FIG. 1 is a block diagram of a central processing unit (CPU), showing a left data path processor and a right data path processor incorporating an embodiment of the invention;

FIG. 2 is a block diagram of the CPU of FIG. 1 showing in detail the left data path processor and the right data path processor, each processor communicating with a register file, a local memory, a first-in-first-out (FIFO) system and a main memory, in accordance with an embodiment of the invention;

FIG. 3 is a block diagram of a multiprocessor system including multiple CPUs of FIG. 1 showing a processor core (left and right data path processors) communicating with left and right external local memories, a main memory and a FIFO system, in accordance with an embodiment of the invention;

FIG. 4 is a block diagram of a multiprocessor system showing local memory banks, in which each memory bank is disposed physically between a CPU to its left and a CPU to its right, in accordance with an embodiment of the invention;

FIG. 5A illustrates a data bit field for a table-address-info operand used by a custom instruction for accessing a table in memory, in accordance with an embodiment of the invention;

FIG. 5B illustrates a physical implementation of a custom instruction, LM-LUT (local-memory-lookup table), in accordance with an embodiment of the invention;

FIG. 5C illustrates a data bit field for the table-address-info operand when used as an output by the LM-LUT instruction upon completing the lookup instruction, in accordance with an embodiment of the invention;

FIG. 6 illustrates three level lookup tables, each having a different memory size requirement, and accessible by multiple processors using LM-LUT instructions, in accordance with an embodiment of the invention;

FIG. 7 illustrates assignments of local memory (LM) pages amongst the multiple processors, in order to satisfy size requirements of the three level lookup tables of FIG. 6, in accordance with an embodiment of the invention; and

FIG. 8 is an illustration of computer code used by three processors for variable length decoding (VLD) a bitstream of data, using the custom LM-LUT instruction, in accordance with an embodiment of the invention.

### DETAILED DESCRIPTION OF THE INVENTION

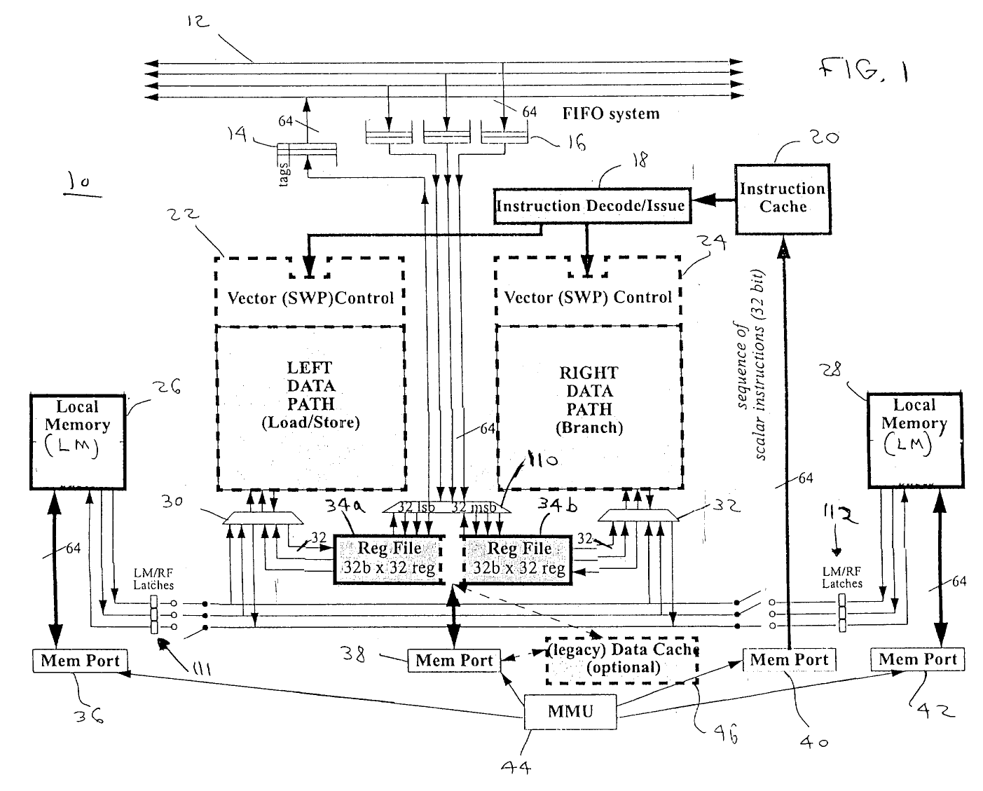

Referring to FIG. 1, there is shown a block diagram of a central processing unit (CPU), generally designated as 10. CPU 10 is a two-issue-super-scalar (2i-SS) instruction processor-core capable of executing multiple scalar instructions simultaneously or executing one vector instruction. A left data path processor, generally designated as 22, and a right data path processor, generally designated as 24, receive scalar or vector instructions from instruction decoder 18.

Instruction cache 20 stores read-out instructions, received from memory port 40 (accessing main memory), and provides them to instruction decoder 18. The instructions are decoded by decoder 18, which generates signals for the execution of each instruction, for example signals for controlling sub-word parallelism (SWP) within processors 22 and 24 and signals for transferring the contents of fields of the instruction to other circuits within these processors.

CPU 10 includes an internal register file which, when executing multiple scalar instructions, is treated as two separate register files 34a and 34b, each containing 32 registers, each having 32 bits. This internal register file, when executing a vector instruction, is treated as 32 registers, each having 64 bits. Register file 34 has four 32-bit read and two write (4R/2W) ports. Physically, the register file is 64 bits wide, but it is split into two 32-bit files when processing scalar instructions.

When processing multiple scalar instructions, two 32-bit wide instructions may be issued in each clock cycle. Two 32-bit wide data may be read from register file 32 from left data path processor 22 and right data path processor 24, by way of multiplexers 30 and 32. Conversely, 32-bit wide data may be written to register file 32 from left data path processor 22 and right data path processor 24, by way of multiplexers 30 and 32. When processing one vector instruction, the left and right 32 bit register files and read/write ports are joined together to create a single 64-bit register file that has two 64-bit read ports and one write port (2R/1W).

CPU 10 includes a level-one local memory (LM) that is externally located of the core-processor and is split into two halves, namely left LM 26 and right LM 28. There is one clock latency to move data between processors 22, 24 and left and right LMs 26, 28. Like register file 34, LM 26 and 28 are each physically 64 bits wide.

It will be appreciated that in the 2i-SS programming model, as implemented in the Sparc architecture, two 32-bit wide instructions are consumed per clock. It may read and write to the local memory with a latency of one clock, which is done via load and store instructions, with the LM given an address in high memory. The 2i-SS model may also issue pre-fetching loads to the LM. The SPARC ISA has no instructions or operands for LM. Accordingly, the LM is treated as memory, and-accessed by load and store instructions. When vector instructions are issued, on the other hand, their operands may come from either the LM or the register file (RF). Thus, up to two 64-bit data may be read from the register file, using both multiplexers (30 and 32) working in a coordinated manner. Moreover, one 64 bit datum may also be written back to the register file. One superscalar instruction to one datapath may move a maximum of 32 bits of data, either from the LM to the RF (a load instruction) or from the RF to the LM (a store instruction).

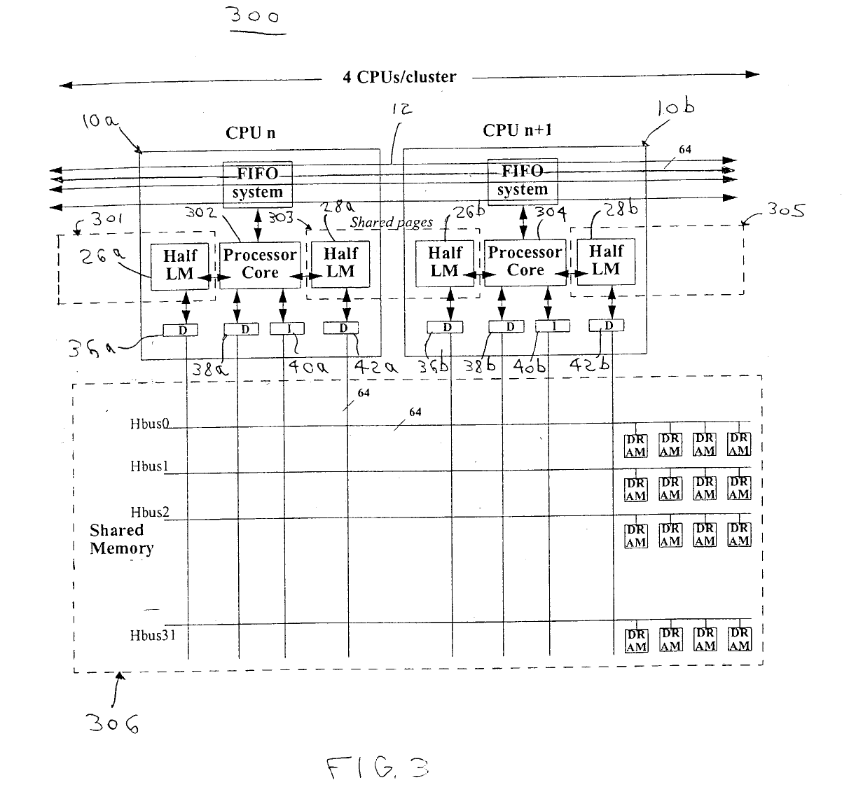

Four memory ports for accessing a level-two main memory of dynamic random access memory (DRAM) (as shown in FIG. 3) are included in CPU 10. Memory port 36 provides 64-bit data to or from left LM 26. Memory port 38 provides 64-bit data to or from register file 34, and memory port 42 provides data to or from right LM 28. 64-bit instruction data is provided to instruction cache 20 by way of memory port 40. Memory management unit (MMU) 44 controls loading and storing of data between each memory port and the DRAM. An optional level-one data cache, such as SPARC legacy data cache 46, may be accessed by CPU 10. In case of a cache miss, this cache is updated by way of memory port 38 which makes use of MMU 44.

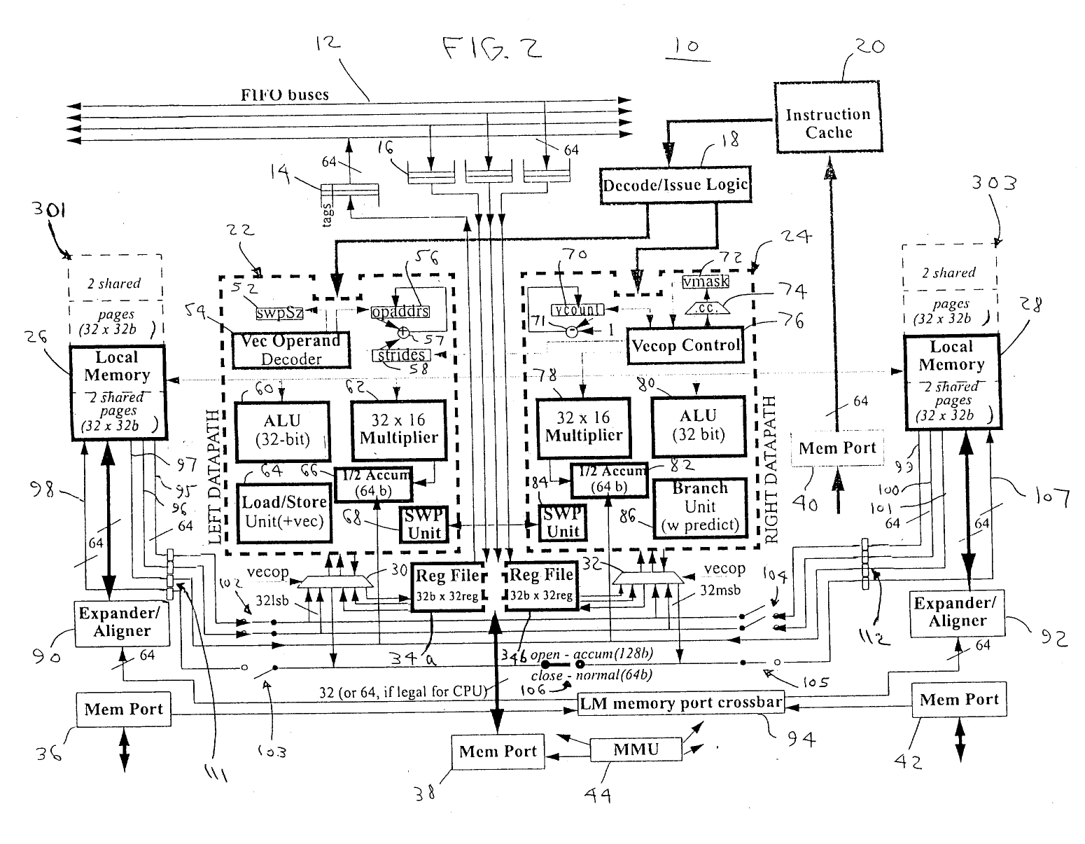

CPU 10 may issue two kinds of instructions: scalar and vector. Using instruction level parallelism (ILP), two independent scalar instructions may be issued to left data path processor 22 and right data path processor 24 by way of memory port 40. In scalar instructions, operands may be delivered from register file 34 and load/store instructions may move 32-bit data from/to the two LMs. In vector instructions, combinations of two separate instructions define a single vector instruction, which may be issued to both data paths under control of a vector control unit (as shown in FIG. 2). In vector instruction, operands may be delivered from the LMs and/or register file 34. Each scalar instruction processes 32 bits of data, whereas each vector instruction may process N×64 bits (where N is the vector length).

CPU 10 includes a first-in first-out (FIFO) buffer system having output buffer FIFO 14 and three input buffer FIFOs 16. The FIFO buffer system couples CPU 10 to neighboring CPUs (as shown in FIG. 3) of a multiprocessor system by way of multiple busses 12. The FIFO buffer system may be used to chain consecutive vector operands in a pipeline manner. The FIFO buffer system may transfer 32-bit or 64-bit instructions/operands from CPU 10 to its neighboring CPUs. The 32-bit or 64-bit data may be transferred by way of bus splitter 110.

Referring next to FIG. 2, CPU 10 is shown in greater detail. Left data path processor 22 includes arithmetic logic unit (ALU) 60, half multiplier 62, half accumulator 66 and sub-word processing (SWP) unit 68. Similarly, right data path processor 24 includes ALU 80, half multiplier 78, half accumulator 82 and SWP unit 84. ALU 60, 80 may each operate on 32 bits of data and half multiplier 62, 78 may each multiply 32 bits by 16 bits, or 2×16 bits by 16 bits. Half accumulator 66, 82 may each accumulate 64 bits of data and SWP unit 68, 84 may each process 8 bit, 16 bit or 32 bit quantities.

Non-symmetrical features in left and right data path processors include load/store unit 64 in left data path processor 22 and branch unit 86 in right data path processor 24. With a two-issue super scalar instruction, for example, provided from instruction decoder 18, the left data path processor includes instruction to the load/store unit for controlling read/write operations from/to memory, and the right data path processor includes instructions to the branch unit for branching with prediction. Accordingly, load/store instructions may be provided only to the left data path processor, and branch instructions may be provided only to the right data path processor.

For vector instructions, some processing activities are controlled in the left data path processor and some other processing activities are controlled in the right data path processor. As shown, left data path processor 22 includes vector operand decoder 54 for decoding source and destination addresses and storing the next memory addresses in operand address buffer 56. The current addresses in operand address buffer 56 are incremented by strides adder 57, which adds stride values stored in strides buffer 58 to the current addresses stored in operand address buffer 56.

It will be appreciated that vector data include vector elements stored in local memory at a predetermined address interval. This address interval is called a stride. Generally, there are various strides of vector data. If the stride of vector data is assumed to be “1”, then vector data elements are stored at consecutive storage addresses. If the stride is assumed to be “8”, then vector data elements are stored 8 locations apart (e.g. walking down a column of memory registers, instead of walking across a row of memory registers). The stride of vector data may take on other values, such as 2 or 4.

Vector operand decoder 54 also determines how to treat the 64 bits of data loaded from memory. The data may be treated as two-32 bit quantities, four-16 bit quantities or eight-8 bit quantities. The size of the data is stored in sub-word parallel size (SWPSZ) buffer 52.

The right data path processor includes vector operation (vecop) controller 76 for controlling each vector instruction. A condition code (CC) for each individual element of a vector is stored in cc buffer 74. A CC may include an overflow condition or a negative number condition, for example. The result of the CC may be placed in vector mask (Vmask) buffer 72.

It will be appreciated that vector processing reduces the frequency of branch instructions, since vector instructions themselves specify repetition of processing operations on different vector elements. For example, a single instruction may be processed up to 64 times (e.g. loop size of 64). The loop size of a vector instruction is stored in vector count (Vcount) buffer 70 and is automatically decremented by “1”via subtractor 71. Accordingly, one instruction may cause up to 64 individual vector element calculations and, when the Vcount buffer reaches a value of “0”, the vector instruction is completed. Each individual vector element calculation has its own CC.

It will also be appreciated that because of sub-word parallelism capability of CPU 10, as provided by SWPSZ buffer 52, one single vector instruction may process in parallel up to 8 sub-word data items of a 64 bit data item. Because the mask register contains only 64 entries, the maximum size of the vector is forced to create no more SWP elements than the 64 which may be handled by the mask register. It is possible to process, for example, up to 8×64 elements if the operation is not a CC operation, but then there may be potential for software-induced error. As a result, the invention limits the hardware to prevent such potential error.

Turning next to the internal register file and the external local memories, left data path processor 22 may load/store data from/to register file 34a and right data path processor 24 may load/store data from/to register file 34b, by way of multiplexers 30 and 32, respectively. Data may also be loaded/stored by each data path processor from/to LM 26 and LM 28, by way of multiplexers 30 and 32, respectively. During a vector instruction, two-64 bit source data may be loaded from LM 26 by way of busses 95, 96, when two source switches 102 are closed and two source switches 104 are opened. Each 64 bit source data may have its 32 least significant bits (LSB) loaded into left data path processor 22 and its 32 most significant bits (MSB) loaded into right data path processor 24. Similarly, two-64 bit source data may be loaded from LM 28 by way of busses 99, 100, when two source switches 104 are closed and two source switches 102 are opened.

Separate 64 bit source data may be loaded from LM 26 by way of bus 97 into half accumulators 66, 82 and, simultaneously, separate 64 bit source data may be loaded from LM 28 by way of bus 101 into half accumulators 66, 82. This provides the ability to preload a total of 128 bits into the two half accumulators.

Separate 64-bit destination data may be stored in LM 28 by way of bus 107, when destination switch 105 and normal/accumulate switch 106 are both closed and destination switch 103 is opened. The 32 LSB may be provided by left data path processor 22 and the 32 MSB may be provided by right data path processor 24. Similarly, separate 64-bit destination data may be stored in LM 26 by way of bus 98, when destination switch 103 and normal/accumulate switch 106 are both closed and destination switch 105 is opened. The load/store data from/to the LMs are buffered in left latches 111 and right latches 112, so that loading and storing may be performed in one clock cycle.

If normal/accumulate switch 106 is opened and destination switches 103 and 105 are both closed, 128 bits may be simultaneously written out from half accumulators 66, 82 in one clock cycle. 64 bits are written to LM 26 and the other 64 bits are simultaneously written to LM 28.

LM 26 may read/write 64 bit data from/to DRAM by way of LM memory port crossbar 94, which is coupled to memory port 36 and memory port 42. Similarly, LM 28 may read/write 64 bit data from/to DRAM. Register file 34 may access DRAM by way of memory port 38 and instruction cache 20 may access DRAM by way of memory port 40. MMU 44 controls memory ports 36, 38, 40 and 42.

Disposed between LM 26 and the DRAM is expander/aligner 90 and disposed between LM 28 and the DRAM is expander/aligner 92. Each expander/aligner may expand (duplicate) a word from DRAM and write it into an LM. For example, a word at address 3 of the DRAM may be duplicated and stored in LM addresses 0 and 1. In addition, each expander/aligner may take a word from the DRAM and properly align it in a LM. For example, the DRAM may deliver 64 bit items which are aligned to 64 bit boundaries. If a 32 bit item is desired to be delivered to the LM, the expander/aligner automatically aligns the delivered 32 bit item to 32 bit boundaries.

External LM 26 and LM 28 will now be described by referring to FIGS. 2 and 3. Each LM is physically disposed externally of and in between two CPUs in a multiprocessor system. As shown in FIG. 3, multiprocessor system 300 includes 4 CPUs per cluster (only two CPUs shown). CPUn is designated 10a and CPUn+1 is designated 10b. CPUn includes processor-core 302 and CPUn+1 includes processor-core 304. It will be appreciated that each processor-core includes a left data path processor (such as left data path processor 22) and a right data path processor (such as right data path processor 24).

A whole LM is disposed between two CPUs. For example, whole LM 301 is disposed between CPUn and CPUn−1 (not shown), whole LM 303 is disposed between CPUn and CPUn+1, and whole LM 305 is disposed between CPUn+1 and CPUn+2 (not shown). Each whole LM includes two half LMs. For example, whole LM 303 includes half LM 28a and half LM 26b. By partitioning the LMs in this manner, processor core 302 may load/store data from/to half LM 26a and half LM 28a. Similarly, processor core 304 may load/store data from/to half LM 26b and half LM 28b.

As shown in FIG. 2, whole LM 301 includes 4 pages, with each page having 32×32 bit registers. Processor core 302 (FIG. 3) may typically access half LM 26a on the left side of the core and half LM 28a on the right side of the core. Each half LM includes 2 pages. In this manner, processor core 302 and processor core 304 may each access a total of 4 pages of LM.

It will be appreciated, however, that if processor core 302 (for example) requires more than 4 pages of LM to execute a task, the operating system may assign to processor core 302 up to 4 pages of whole LM 301 on the left side and up to 4 pages of whole LM 303 on the right side. In this manner, CPUn may be assigned 8 pages of LM to execute a task, should the task so require.

Completing the description of FIG. 3, busses 12 of each FIFO system of CPUn and CPUn+1 corresponds to busses 12 shown in FIG. 2. Memory ports 36a, 38a, 40a and 42a of CPUn and memory ports 36b, 38b, 40b and 42b of CPUn+1 correspond, respectively, to memory ports 36, 38, 40 and 42 shown in FIG. 2. Each of these memory ports may access level-two memory 306 including a large crossbar, which may have, for example, 32 busses interfacing with a DRAM memory area. A DRAM page may be, for example, 32 K Bytes and there may be, for example, up to 128 pages per 4 CPUs in multiprocessor 300. The DRAM may include buffers plus sense-amplifiers to allow a next fetch operation to overlap a current read operation.

The manner in which an operating system (OS) assigns left/right LM pages to each cooperating CPU will now be discussed. Referring to FIG. 4, there is shown multiprocessing system 400 including CPU 0, CPU 1 and CPU 2 (for example). Four banks of LMs are included, namely LM0, LM1, LM2 and LM3. Each LM is physically interposed between two CPUs and, as shown, is designated as belonging to a left CPU and/or a right CPU. For example, the LM1 bank is split into left (L) LM and right (R) LM, where left LM is to the right of CPU 0 and right LM is to the left of CPU 1. The other LM banks are similarly designated.

In an embodiment of the invention, the compiler determines the number of left/right LM pages (up to 4 pages) needed by each CPU in order to execute a respective task. The OS, responsive to the compiler, searches its main memory (DRAM, for example) for a global table of LM page usage to determine which LM pages are unused. The OS then reserves a contiguous group of CPUs to execute the respective tasks and also reserves LM pages for each of the respective tasks. The OS performs the reservation by writing the task number for the OS process in selected LM pages of the global table. The global table resides in main memory and is managed by the OS.

Since the LM is architecturally visible to the programmer, just like register file 34, a custom instruction may be implemented using the LM as a lookup table, in accordance with an embodiment of the invention. As will be discussed, the present invention provides multi-level lookup tables in the LM that may be quickly accessed by one or multiple processors using the custom instruction. Each processor may be assigned, by the operating system, pages in the LM to satisfy compiler requirements for executing various tasks. The operating system may allocate different amounts of LM space to each processor to accomplish the multi-level look up instruction, quickly and efficiently.

In one exemplary embodiment of the invention, a custom instruction, LM-LUT (local memory-lookup table) will now be discussed. The syntax of the LM-LUT instruction, for example, may be as follows:

LM-LUT table-address-info data-source destination-register

where all three operands are registers in the CPU register file. The table-address-info operand has three components:

Offset MSB (in data)—the bit of the data-source which is the MSB of the offset,

Offset LSB (in data)—the bit of the data-source which is the LSB of the offset,

LUT base register—the LM register that contains the first entry of the lookup table.

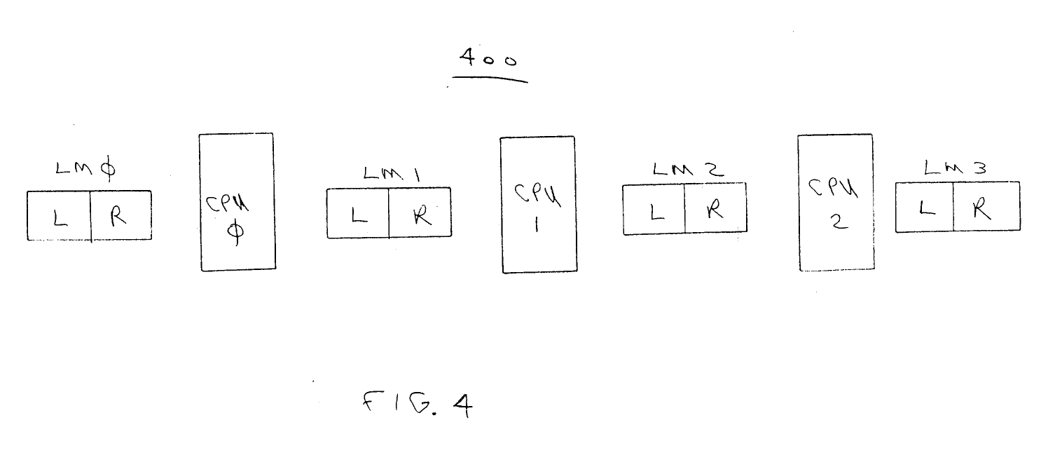

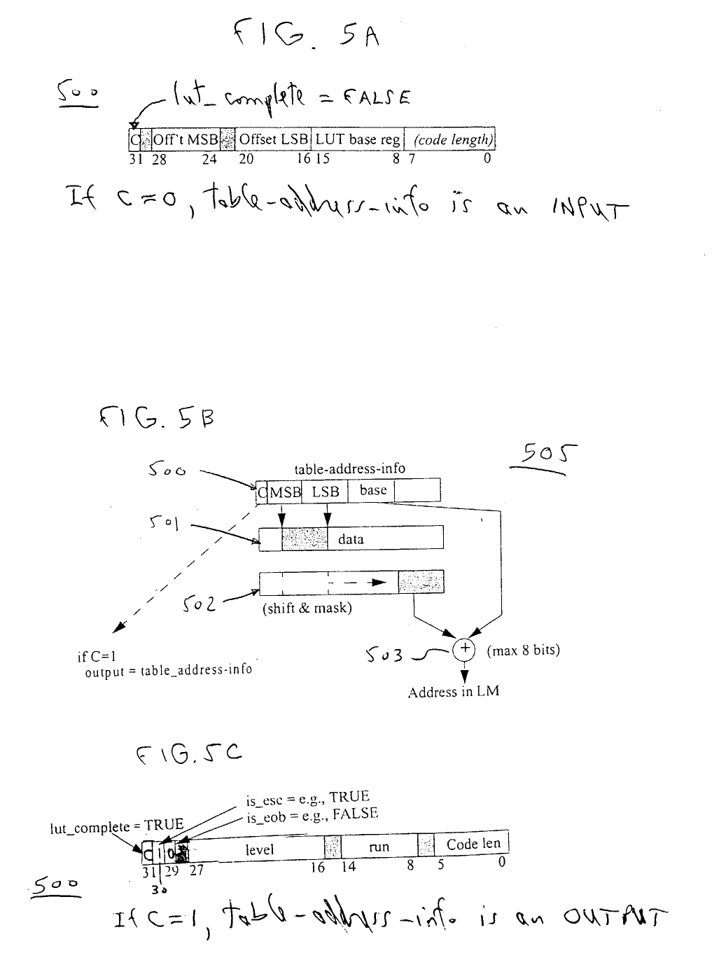

The table-address-info operand is shown in FIG. 5A and is generally designated as 500. Bits 0-7 are reserved for code length, which is output when the lookup instruction is completed. The offset MSB and offset LSB select a bitfield in the data-source (operand 2). The LUT base register field selects an address of the table entry, as described below, which is fetched from the LM and placed into the destination-register (operand 3). The programmer must enforce that the number of bits in the offset field matches the size of the table. For example, if the MSB is 15 and the LSB is 10 (6 bit field), then the table size must be 64.

The semantics of the instruction are as follows. The offset MSB and offset LSB select a bitfield in the data source (operand 2). The offset defined by those bits of the data source is added to the LUT base register to produce the address of the table entry. That table entry is fetched from LM and placed into the destination register (operand 3).

The LM-LUT instruction has one side effect. If the table entry has its MSB set, then a condition code flag is set. This condition code is used to test whether the lookup has reached valid data, or if the retrieved data is to be reused as the table-address-info of a subsequent lookup. This flag allows multi-level lookups to be chained efficiently. This flag is shown as C in bit position 31 (FIGS. 5A and 5C). If C=0, then the retrieved data is reused as the table-address-info for a subsequent lookup. If C=1, however, the retrieved data is valid data and is used as an output indicating a completed lookup.

If the C flag is set to 1 (FIG. 5C) in the table-address-info operand of an LM LUT instruction, then that input operand is copied unchanged into the destination-register output operand. That is, for completed lookups, the LM LUT operations is idempotent (i.e., the input is unchanged by the operation). This avoids cycle-consuming test-and-branch programming. Since some codewords require two lookups to determine codeword length, Im_lut may be called twice in a row. For those codes which are complete after one lookup, the C flag preserves that result during the second lookup. Consequently, if the C flag is false (0), then an actual LM LUT instruction will be performed. If the flag is true (1), then the table-address-info input operand is copied directly into the destination register output operand by the LM LUT hardware.

FIG. 5B depicts the physical implementation of the LM LUT instruction, generally designated as 505. The MSB and LSB fields of table-address-info operand 500 cause the LM-LUT hardware to select bitfield 501 of the data-source input operand. That selected bitfield 501 is shifted and masked by the LM-LUT hardware to create the offset value 502 of this particular lookup inside the table. That offset is added to the LUT base subfield of the table-address-info operand by adder 503 to create the LM address to be accessed by this particular lookup. That address is output to the LM memory system in the first clock tic of an LM-LUT instruction.

In the embodiment of FIG. 4, all adjacent pages (4 pages per LM bank) may be assigned to one CPU (e.g. 8 pages). As a result, the maximum size of an LM-LUT is 256 entries (8 pages×32 registers per page=256 entries). With 256 entries, the maximum value produced by adder 503 is 8 bits (2⁸). The combined shift/mask-add may easily be accomplished within one clock cycle.

An example of using the LM-LUT instruction is in variable length decoding (VLD) and is discussed next. It should be appreciated, however, that the invention may be applied to access any kind of entries stored in multi-level tables for applications other than VLD. The discussion below, therefore, does not intent to limit the invention to using a LM-LUT instruction for VLD only.

A variable length decoder may be considered to be a complicated lookup table. One benefit of a multi-level lookup table is that the length of the codeword may be found before a complete decode reveals the actual {run, amplitude} values. Thus, a multi-level table allows pipelining the lookup process to achieve a higher clock rate. As will be explained, a multi-level lookup is used to assure shifting of one codeword every seven clocks.

The code length of all MPEG codewords may be determined in no more than two lookups, using small tables that fit inside the LM. These two lookups may be accomplished within the seven clocks. Some {run, amplitude} values, however, require a third lookup table. The invention, as described later, allocates three CPUs to finish the decoding process. Partial (or complete) VLD codes are forwarded from the first CPU to the other CPUs via the FIFO system shown in FIG. 1. First, the VLD code tables will be described.

As an example, the codes shown in the following tables use the B-15 (not-intra-coded) VLD table for MPEG2. As shown in Tables 2A and 2B the shortest code length is 2+sign (2+s) bits long. The longest code is 16+s bits long. Escape codes have a 6-bit escape prefix followed by a 6-bit run and a 12-bit amplitude. Codes may begin with strings of leading zeroes or strings of leading ones. This complicates decoding because it requires more short tables. Nevertheless, after analyzing the B-15 VLD table for MPEG2, the inventors built a few small lookup tables that allow the code length of any MPEG2 codeword to be found in two lookups.

TABLE 2A
Possible Code Lengths per Number of Leading Zeros

| | Possible code |
|---|---|
| # Leading 0s | lengths |
| 1 | 3 + s |
| | 4 + s |
| | 4 |
| 2 | 5 + s |
| | 8 + s |
| 3 | 6 + s |
| 4 | 7 + s |
| 5 | 6(esc) |
| 6 | 9 + s |
| | 10 + s |
| 7 | 12 + s |
| 8 | 13 + s |
| 9 | 14 + s |
| 10 | 15 + s |
| 11 | 16 + s |

TABLE 2B
Possible Code Lengths per Number of Leading Ones.

| | Possible code |
|---|---|
| # Leading 1s | lengths |
| 1 | 2 + s |
| 2 | 3 + s |
| 3 | 5 + s |
| 4 | 7 + s |
| 5 | 7 + s |
| | 8 + s |
| 6 | 8 + s |
| 7 | 8 + s |

As shown in Tables 2A and 2B, by counting leading ones or leading zeroes, the code length may be determined in all but four cases (number of leading zeroes—1, 2, and 6; number of leading ones—5). The maximum number of leading bits needed to determine the code length is 11. The decoding of 11 bits may be broken into a 6-bit decode (64 entry LUT) followed by a 5-bit decode (32 entry LUT). The first 6-bit decode (64 entries) is shown in Tables 3A and 3B. Table 3A shows the first 6-bits with leading zeroes and table 3B shows the first 6-bits with leading ones.

TABLE 3A
LEADING ZEROES LUT (first half of 6-bit LUT)

| | | LUT2 |
|---|---|---|
| 1st 6 bits | len, {run, amp, sign} | name |
| 0000 00 | Go to 6 Lead 0s LUT | (F-K) |
| 0000 01 | 6 {escape} | — |
| 0000 10 | 7 + s {?, ?, ?} | B |
| 0000 11 | 7 + s {?, ?, ?} | B |
| 0001 00 | 6 + s {0, 7, ?} | A |
| 0001 01 | 6 + s {0, 6, ?} | A |
| 0001 10 | 6 + s {4, 1, ?} | A |
| 0001 11 | 6 + s {5, 1, ?} | A |
| 0010 00 | 8 + s {?, ?, ?} | D |
| 0010 01 | 8 + s {?, ?, ?} | D |
| 0010 10 | 5 + s {2, 1, +} | — |
| 0010 11 | 5 + s {2, 1, −} | — |
| 0011 00 | 5 + s {1, 2, +} | — |
| 0011 01 | 5 + s {1, 2, −} | — |
| 0011 10 | 5 + s {3, 1, +} | — |
| 0011 11 | 5 + s {3, 1, −} | — |
| 0100 00 | 3 + s {1, 1, +} | — |
| 0100 01 | ″ | — |
| 0100 10 | ″ | — |
| 0100 11 | ″ | — |
| 0101 00 | 3 + s {1, 1, −} | — |
| 0101 01 | ″ | — |
| 0101 10 | ″ | — |
| 0101 11 | ″ | — |
| 0110 00 | 4 {eob} | — |
| 0110 01 | ″ | — |
| 0110 10 | ″ | — |
| 0110 11 | ″ | — |
| 0111 00 | 4 + s {0, 3, +} | — |
| 0111 01 | 4 + s {0, 3, −} | — |
| 0111 10 | 4 + s {0, 3, +} | — |
| 0111 11 | 4 + s {0, 3, −} | — |

TABLE 3B
LEADING ONES LUT (second half of 6-bit LUT)

| | | LUT2 |
|---|---|---|
| 1st 6 bits | len, {run, amp, sign} | name |
| 1000 00 | 2 + s {0, 1, +} | — |
| 1000 01 | ″ | — |
| 1000 10 | ″ | — |
| 1000 11 | ″ | — |
| 1001 00 | ″ | — |
| 1001 01 | ″ | — |
| 1001 10 | ″ | — |
| 1001 11 | ″ | — |
| 1010 00 | 2 + s {0, 1, −} | — |
| 1010 01 | ″ | — |
| 1010 10 | ″ | — |
| 1010 11 | ″ | — |
| 1011 00 | ″ | — |
| 1011 01 | ″ | — |
| 1011 10 | ″ | — |
| 1011 11 | ″ | — |
| 1100 00 | 3 + s {0, 2, +} | — |
| 1100 01 | ″ | — |
| 1100 10 | ″ | — |
| 1100 11 | ″ | — |
| 1101 00 | 3 + s {0, 2, −} | — |
| 1101 01 | ″ | — |
| 1101 10 | ″ | — |
| 1101 11 | ″ | — |
| 1110 00 | 5 + s {0, 4, +} | — |
| 1110 01 | 5 + s {0, 4, −} | — |
| 1110 10 | 5 + s {0, 5, +} | — |
| 1110 11 | 5 + s {0, 5, −} | — |
| 1111 00 | 7 + s {?, ?, ?} | C |
| 1111 01 | ″ | C |
| 1111 10 | Go to 5 Lead 1s LUT | — |
| 1111 11 | 8 + s {?, ?, ?} | E |

All codewords in Table 3A may be completely decoded in one lookup, including the escape code, except for the top 9 entries in the table (omitting the escape code). The first code entry (0000 00) requires going to a second table, the 6-lead-zeroes LUT, which requires, in turn, a third table. The remaining 8 code lengths may be completely decoded in two lookups, using the indicated second LUT, namely tables B, A and D.

All codewords in Table 3B may be completely decoded in one lookup except for the bottom four (beginning with 1111). Three of these four codewords may be decoded by going to tables C or E, and one of these four codewords (1111 10) may be decoded by going to the 5-lead-ones-LUT. Nevertheless, these four codewords may be completely decoded in two lookup tables.

The second layer code tables for bits 7-11 are shown in Tables 4 and 5. Table 4 (LUT 2) is accessed if the first 6 bits in LUT 1 are “0000 00”. Table 5 (LUT 2) is accessed if the first 6 bits in LUT 1 are “1111 10”.

TABLE 4
Six LEADING ZEROS LUT (second level LUT)

| | | LUT3 |
|---|---|---|
| 2nd 5 bits | len, {run, amp, sign} | name |
| 00 000 | 16 + s {?, ?, ?} | K |
| 00 001 | 15 + s {?, ?, ?} | J |
| 00 010 | 14 + s {?, ?, ?} | H |
| 00 011 | 14 + s {?, ?, ?} | H |
| 00 100 | 13 + s {?, ?, ?} | G |
| 00 101 | 13 + s {?, ?, ?} | G |
| 00 110 | 13 + s {?, ?, ?} | G |
| 00 111 | 13 + s {?, ?, ?} | G |
| 01 000 | 12 + s {8, 2, ?} | F |
| 01 001 | 12 + s {4, 3, ?} | F |
| 01 010 | 12 + s {7, 2, ?} | F |
| 01 011 | 12 + s {?, ?, ?} | F |
| 01 100 | 12 + s {19, 1, ?} | F |
| 01 101 | 12 + s {18, 1, ?} | F |
| 01 110 | 12 + s {3, 3, ?} | F |
| 01 111 | 12 + s {?, ?, ?} | F |
| 10 000 | 9 + s {5, 2, +} | — |
| 10 001 | 9 + s {5, 2, +} | — |
| 10 010 | 9 + s {5, 2, −} | — |
| 10 011 | 9 + s {5, 2, −} | — |
| 10 100 | 9 + s {14, 1, +} | — |
| 10 101 | 9 + s {14, 1, +} | — |
| 10 110 | 9 + s {14, 1, −} | — |
| 10 111 | 9 + s {14, 1, −} | — |
| 11 000 | 10 + s {2, 4, +} | — |
| 11 001 | 10 + s {2, 4, −} | — |
| 11 010 | 10 + s {16, 1, +} | — |
| 11 011 | 10 + s {16, 1, −} | — |
| 11 100 | 9 + s {15, 1, +} | — |
| 11 101 | 9 + s {15, 1, +} | — |
| 11 110 | 9 + s {15, 1, −} | — |
| 11 111 | 9 + s {15, 1, −} | — |

TABLE 5
Five LEADING ONES LUT (second level LUT)

| 2nd 3 bits | len, {run, amp, sign} |
|---|---|
| 00 0 | 7 + s {0, 9, +} |
| 00 1 | ″ |
| 01 0 | 7 + s {0, 9, −} |
| 01 1 | ″ |
| 10 0 | 8 + s {0, 12, +} |
| 10 1 | 8 + s {0, 12, −} |
| 11 0 | 8 + s {0, 13, +} |
| 11 1 | 8 + s {0, 13, −} |

The upper half of the codes in Table 4 (LUT 2) requires a third table (LUT 3). All of the codes in Table 5 (LUT 2) are completely decoded.

Selection of one of the second tables may be implemented by the chaining procedure described previously. Thus, the total table size needed to determine code length, for the above two lookups, is 64+32+8=104 entries. This requires 104 registers in the LM and fits in four LM pages having a size of 128 registers.

In order to complete the decoding beyond the first level lookup required for some of the codes in Tables 3A-3B, small tables A-E may be used for level two lookups. The sizes of tables A-E (LUT 2) are summarized in Table 6. As shown, each of the tables A, B, C and E has 3 bit size codes and, therefore, requires a table size of 8. Table D, on the other hand, has 4 bit size codes, and, therefore, requires a table size of 16 (actual code words are not shown for Tables A-E). The sum of the table sizes is 48 and requires 48 registers in the LM.

In order to complete the decoding beyond the second lookup required for some of the codes in Table 4, tables F-K may be used for level three lookups. The sizes of the tables F-K (LUT 3) are summarized in Table 7. As shown, each table F-K has 5 bit size codes and, therefore, requires a table size of 32 (actual codewords are not shown for tables F-K). The sum of the table sizes is 160 and requires 160 registers in the LM.

TABLE 6
Summary of Sizes of Tables A-E (LUT 2)

| | | Shift needed | | | | |
|---|---|---|---|---|---|---|
| | | to align | Bits in | Table | Table | Total |
| Code length | Code Prefix | final table | final table | size | name | #lookups |
| 6 + s | 0001 | 4 | 2 + s = 3 | 8 | A | 2 |
| 7 + s | 0000 1 | 5 | 2 + s = 3 | 8 | B | 2 |
| 7 + s | 1111 0 | 5 | 2 + s = 3 | 8 | C | 2 |
| 8 + s | 0010 0 | 5 | 3 + s = 4 | 16 | D | 2 |
| 8 + s | 1111 11 | 6 | 2 + s = 3 | 8 | E | 2 |
| | | | SUM A-E sizes = | 48 | | |

TABLE 7
Summary of Sizes of Tables F-K (LUT 3)

| | | Shift needed | | | | |
|---|---|---|---|---|---|---|
| | | to align | Bits in | Table | Table | Total # |
| Code length | Code prefix | final table | final table | size | name | lookups |
| 12 + s | 0000 0001 | 8 | 4 + s = 5 | 32 | F | 3 |
| 13 + s | 0000 0000 1 | 9 | 4 + s = 5 | 32 | G | 3 |
| 14 + s | 0000 0000 01 | 10 | 4 + s = 5 | 32 | H | 3 |
| 15 + s | 0000 0000 001 | 11 | 4 + s = 5 | 32 | J | 3 |
| 16 + s | 0000 0000 0001 | 12 | 4 + s = 5 | 32 | K | 3 |
| | | | SUM F-K sizes = | 160 | | |

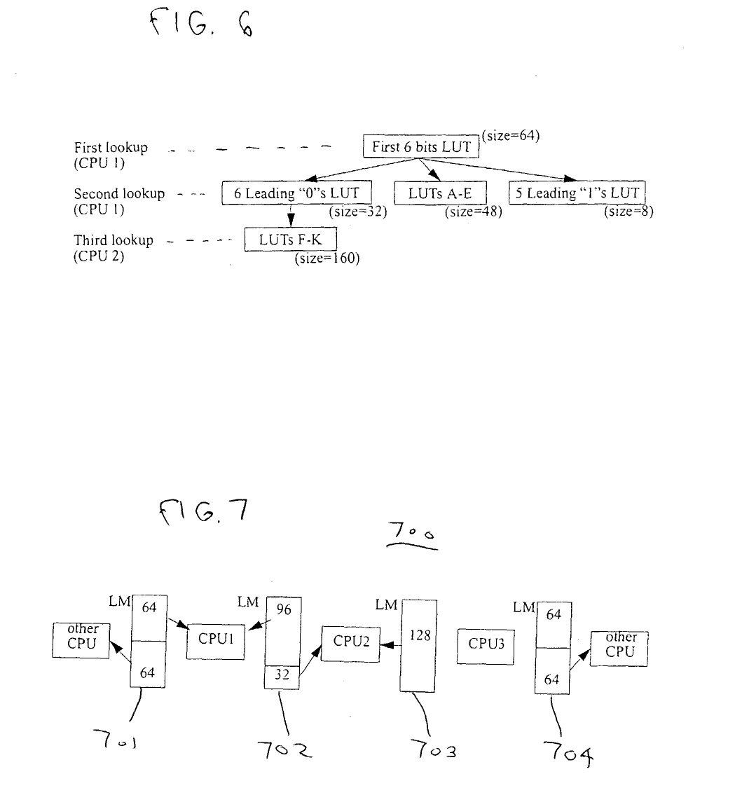

Referring next to FIG. 6, there is shown the three level lookup tables and their order of usage as allocated among three processors. As shown, the size of the first 6-bits LUT is 64 and the size of the 6 leading “0s” LUT is 32. The size of the 5 leading “1s” LUT is 8 and the sizes of LUTs A-E, and F-K are 48 and 160, respectively. The first lookup and second lookup are performed by CPU1 and the third lookup is performed by CPU2.

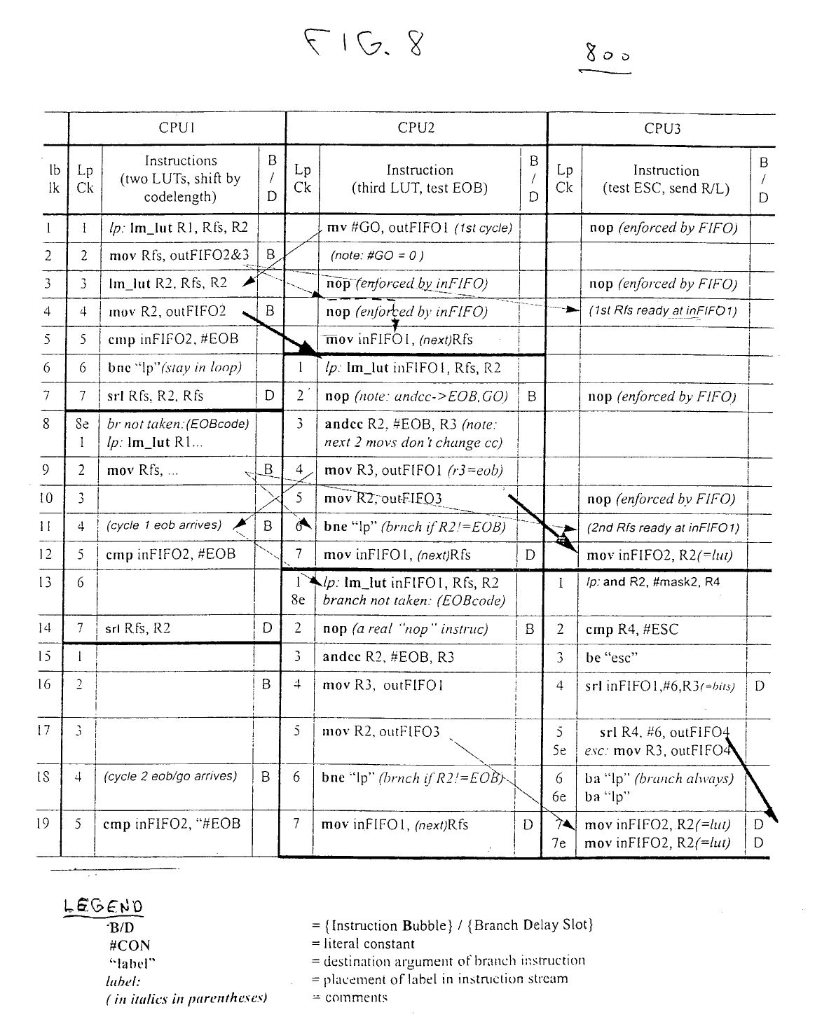

FIG. 7 shows an exemplary multiprocessing system 700 including CPU1, CPU2 and CPU3. CPU1 includes LM bank 701 to its left and LM bank 702 to its right. Similarly, CPU2 includes LM bank 702 to its left and LM bank 703 to its right. Lastly, CPU3 includes LM bank 703 to its left and LM bank 704 to its right.

In the example shown with respect to FIG. 6, the total number of table entries needed by CPU1 is 152. Likewise, CPU2 requires 160 registers. Fortunately, CPU3 does not require any LM registers. As a result, LM pages may be assigned as shown in FIG. 7. As shown, CPU1 is allocated three pages (96 registers) on its right and two pages (64 registers) on its left. CPU2 is allocated 4 pages (128 registers) on its right and 1 page (32 registers) on its left. In this manner, it is possible to allocate to all three CPUs the pages required to perform the VLD calculation.

Based on the exemplary VLD lookup tables, the CPU instructions for determining code length and then shifting by that amount (code length) is shown in Table 8.

TABLE 8
Instructions for Determining Code Length and
Shifting by that Amount for CPU1

| | | Delay | | | |
|---|---|---|---|---|---|
| Clock | | slot/ | | | |
| cycle | Instruction (CPU1) | bubble | Result 1 | Result 2 | Comment |
| 1 | lp: lm_lut R1, Rfs, R2 | | — | — | R1 contains tbl- |
| | | | | | addr-info for “First |
| | | | | | 6 bits” LUT |
| 2 | mov Rfs, outFIFO2 & 3 | bubble | lut-> R2 | Rfs-> FIFO | Rfs = funnel shift |
| | | | | | register |
| 3 | lm_lut R2, Rfs, R2 | | — | — | LUT results placed |
| | (2nd call might have no | | | | in R2 |
| | effect) | | | | |
| 4 | cmp inFIFO2 “eob” | bubble | lut-> R2 | set cc | R2 not ready yet |
| 5 | mov R2, outFIFO2 | | | R2-> FIFO2 | send lookup; cc |
| | | | | | unchanged |
| 6 | bne “lp” | | | set branch | use cc set by |
| | | | | | instruction 4 |
| 7 | srl Rfs, R2(codlen), Rfs | delay | | shifted Rfs | bitfield correctly |
| | (codlen bitfield of Imlut out) | | | | placed to be shift |
| | | | | | value in srl |
| 8e | eob: (code for end of block) | | | | exit loop; run EOB |
| | | | | | code |

It will be appreciated that the instructions shown in Table 8 are conventional SPARC Version 8 ISA instructions, except for the custom “Im_lut” instruction. The SPARC Version 8 ISA is discussed in detail in the SPARC Architecure Manual, Version 8, printed 1992 by SPARC International, Inc., and is incorporated herein in its entirety by reference.

Datastream shifting by CPU1 is accomplished in seven clocks as shown in Table 8. It will be appreciated that Rfs (data in funnel shift register) is forwarded to CPU2 and CPU3 by instruction 2 of CPU1. That “mov” instruction places the Rfs contents into outFIF02 (FIFO accessed by CPU2) and outFIF03 (FIFO accessed by CPU3), respectively. This “mov” instruction is placed in the delay cycle (or bubble) of Im_lut instruction 1. A shift right logical (srl) instruction is performed in clock cycle 7 during a branch delay.

Recall that CPU1 performs two consecutive lookups. These are performed in clock cycle 1 and clock cycle 3 with two LM LUT instructions. Since the LM LUT instruction is idempotent, the second lookup, during clock cycle 3, may have no effect. This is advantageous, because only one lookup may be necessary to find the LUT result; the second lookup, if not necessary, does not change the results of the first lookup. The LUT results are placed in the R2 register. The data in R2 is moved out to CPU2, during the fifth clock cycle, by way of outFIF02 (FIFO accessed by CPU2) for the third lookup (discussed further in FIG. 8).

The funnel shift register (rfs) is a register that is divided into two halves. When the register has been shifted right more than one-half of its total width, the left-half of the register is automatically refilled from the next sequential memory location by means of dedicated hardware. An Rfs effectively presents itself to the CPU as an infinite bit stream. The Rfs may be mapped to an existing, specific, internal register, GPR, while the compiler makes sure that the specific GPR is used, when the code specifies the Rfs.

As one alternative for ensuring that R2 and FIFO occurs simultaneously, the Rfs register may include two write ports. Alternatively, instead of adding a second write port to the Rfs register file, a dedicated wire link from the Rfs register to the FIFO system may be provided. That link may be a special (i.e., inhomogeneous) datapath for supporting inter-CPU communication for the Im_lut results. In addition, to minimize duplication of task-specific hardware (such as Im_lut hardware) across a homogeneous chip multiprocessor (CMP), this special Rfs register may only be implemented in one CPU, and, for that matter, at an outside edge of a group of processors (i.e., CPU0 in FIG. 3, as the outside edge CPU in a cluster of four CPUs, for example). Placement at an edge would minimize disturbance to the regular floorplan of the CMP. The compiler may then be forced to assign this special CPU to algorithms that use the special Rfs register in their calculations.

Still referring to Table 8, “mov” is a move instruction to move the data from the Rfs register into outFIFO 2 (to CPU2) and out FIF03 (to CPU3), as shown in clock cycle 2. The “cmp” is an instruction to compare inFIFO 2 (data coming from CPU2, by way of inFIF02) for an end-of-block (eob) result, found by CPU2, which causes an escape from decoding (discussed further in FIG. 8). The “bne” instruction, in clock cycle 6, is a “branch-if-not-equal” to EOB (that is, branch to the beginning of the loop, if this is not an EOB).

It will be appreciated that the contents of CPU1's Rfs in Table 8 is forwarded to CPU2 and CPU3 during clock cycle 2, because CPU1 may complete shifting Rfs (and thus destroy the data in Rfs), before CPU2 and CPU3 are able to finish decoding the LUT 3 codewords and the escape codewords, respectively. By forwarding a copy of Rfs, CPU1 may proceed to overwrite Rfs without destroying data for CPU2 and CPU3. As better shown in FIG. 8, feedback to CPU1 is required from only CPU2. The detection of an ESC code by CPU3 has no effect on CPU1. Therefore, CPU1 only has to manage one incoming signal from CPU2.

The division of labor among the three CPUs is as follows:

(a) CPU1 manages the shifting (including ESC) and outputs partial or complete lookup results (performing two level lookups).

(b) CPU2 deals with the following cases:

-LUT3: a code needing a third level lookup and a sign bit determination.

-EOB: an {eob} code, which causes an escape from decoding.

(c) CPU3 deals with the following cases:

-ESC: an {escape} code, for which 18 bits are extracted from the Rfs

-DONE: a code completely looked up by CPU1.

The {escape} code is considered to be a completely decoded codeword with an Rfs shift of 24 bits. CPU3 extracts the remainder of {escape} from its copy of Rfs. The {eob} code is a completely decoded codeword with a shift of 4 bits (code length). Only the case of LUT3 requires a further table lookup.

Referring next to FIG. 8, there is shown code used by CPU1, CPU2 and CPU3 for obtaining VLD results, the code generally designated as 800. As shown, the code has a 7-clock throughput. The code uses the SPARC Version 8 ISA, except for the custom “Im_lut” instruction, discussed previously. It will be appreciated that operands entering a FIFO on clock N are available at the destination at the end of clock N+1. Consequently, their first use by a receiving CPU is, as shown, on clock N+2. Arrows in FIG. 8 highlight the inter-CPU FIFO transfers. The heavy arrows indicate a transfer whose timing sets the relative offset between programs on different CPUs.

An important timing issue is stopping upon EOB without loss of data. It will be appreciated that it is illegal, in the MPEG standard, for the first code of a block to be an EOB. In the code, therefore, a dummy #GO is sent by CPU2 during the prologue. This may be done because the MPEG standard guarantees that #EOB cannot be sent on the first cycle. As shown in FIG. 8, by the time CPU1 reaches the EOB test of its second cycle, CPU2 has completed delivering the result of the first cycle's EOB test. Thus, when CPUL eventually receives an EOB, it stops one cycle later than it should.

Fortunately, a valid copy of an unshifted codeword is still available in the Rfs of CPU2 and CPU3. Therefore, the code for dealing with EOB is able to halt CPU3 (the only CPU that does not test or receive the EOB signal) and is able to copy Rfs back from CPU3 to CPU1. The restored Rfs is ready to begin the next block decode.

The cycles necessary to execute the EOB code may be taken from the 0.23 clocks per TV pixel that are not used for the main 7-clock loop, since EOB events are infrequent compared to other VLD decoding.

The relative delay of CPU2 with respect to CPU1 is set by the arrival of Rfs. The inFIF01 of CPU2 buffers one value of Rfs until it is consumed by CPU2. The code of CPU2 does not actually contain any NOPs. The FIFO stalls CPU2 until the next Rfs arrives.

The code for CPU3 does not perform any testing for EOB. It is expected that the EOB handler on CPU1 may halt CPU3 and flush its FIFOs.

CPU3 buffers two copies of Rfs in its FIFO before the first R2 (decoded codeword) arrives. Once starting, CPU3 reads inFIFO1 on every cycle, even if the code is not an ESC. Otherwise, unused Rfs values would pile up and be read incorrectly. Therefore, CPU3 prepares both a normal and an escape result on each cycle. The result used is selected by the “be esc” instruction, and the selected result is forwarded to CPU4 by an appropriate “mov R3, outFIF04” instruction.

Since the format of the LUT output is made equal to the bit order of the run and level in an escape sequence, all that is necessary to produce a valid output is to strip off the code length field of the result by right shifting the field by 6 bits. That may be accomplished by the “srl Rn, #6, Rd” instructions.

Recognizing that a LUT result is an “esc” requires one more detail. A valid lookup for “esc” contains a value of “6”in the code length field. That, by itself, however, is not sufficient to recognize the result as an escape, because there are two other codes with code length 6. Therefore, some kind of “is an escape” signal may be inserted into the LUT entry for “esc”. This may be done by selecting bit 30 as the “is esc” bit (bit 30 in FIG. 5C). Therefore, “mask2”is bit 30 and so is #ESC.

The same method may be used for CPU2 recognition of “eob”. Bit 29 of the VLD format is selected as “is eob” in FIG. 5C. “Mask1” is bit 29 and so is #EOB.

It should be understood that the look-up values for bits 29 and 30 of the table-operand-info datum are defined by the codewords placed into the LUT by the code table designer. In this example application of the LM LUT instruction, these bits are used to identify #EOB and #ESC. But, bits 29 and 30 are not restricted to the VLD application. They may be used for any purpose desired by the code table designer. Notice that it is the CPU code which tests the values of these bits, not any hardware associated with the VLD. In that sense, these bits are “reserved for user applications”.

It will be understood that the code of FIG. 8 is implemented with three CPUs, in which each CPU only has one datapath. The code may easily be modified for each CPU with two datapaths (as shown, for example, in FIGS. 1 and 2). With two datapaths in each CPU, the number of CPUs required to implement the VLD may be reduced from 3 CPUs to 2 CPUs.

Still referring to FIG. 8, the division of labor among the three CPUs will now be explained. CPU1 performs two LM-LUT lookups during clock cycle 1 and clock cycle 3. Clock cycle 1 is at the beginning of the loop (Ip). There is an instruction bubble (B) in clock cycle 2, because the first lookup is completed after two cycles. During the instruction bubble, the current bit stream is sent over to CPU2 and CPU3, by moving Rfs into outFIF02 (destined to CPU2) and outFIF03 (destined to CPU3). In this manner, CPU2 may obtain the Rfs data from inFIF01 and CPU3 may obtain the Rfs from inFIFO1.

It will be appreciated that the code for CPU1 performs two lookups and stores the result of each lookup in the R2 register. Even if the first lookup results in a completely decoded word, the second lookup is still performed. Since the Im_lut instruction is idempotent, the result stored in R2 does not change.

The second lookup (clock cycle 3) causes a bubble. Therefore, in the mean time, R2 is moved into outFIF02 so that CPU2 may obtain R2 by way of inFIF01 (global clock 6, or local clock 1 in CPU2).

Still referring to the code in CPU1, clock cycle 5 performs a compare (cmp) instruction to check for end-of-block (EOB). The value in the inFIF02 (received via outFIFO1 from CPU2) is #GO. Since an MPEG rule states that at least one lookup is performed before an EOB is encountered, the compare (cmp) instruction finds a go-ahead, which implies that an EOB has not been found. As a result, the next instruction (cycle 6) is a branch instruction (branch if not equal-bne) based on the compare (cmp) instruction. Since the EOB has not been found, CPU1 stays in the loop (cycle 6). The bne instruction causes a delay (D). During this delay, the funnel shift register (Rfs) is shifted (srl) during clock cycle 7. Since the bitfield of the lookup table output includes the length of the code, R2 corresponds to the shift.

After the shift is performed, the code branches back to the top of the loop (Ip) and CPU1 is ready to perform the next Im_lut to find the length of the next bitstream (clock cycle 8). If an EOB is received, however, the branch fails and the code moves down to clock cycle 9. It will be appreciated that two instructions shown within the same box, in FIG. 8, implies that these instructions are alternatives. Thus, in clock cycle 8, CPU1 performs either an instruction that handles the EOB code (cycle 8e) or a loop back to the top (cycle 1).

The code executed by CPU2 will be referred to next in FIG. 8. Since not enough time is available to perform a third lookup by CPU1, CPU2 performs the third lookup. Accordingly, CPU1 first places in the FIFO for CPU2 data from the Rfs (move Rfs, outFIF02 and 3). CPU1 then places into the FIFO for CPU2 the result of the two lookups (move R2, outFIF02).

CPU2, in the prologue, first moves the data from inFIF01 into Rfs, so that the funnel shift data is available to CPU2. CPU2 next performs the third lookup immediately by using the result data (R2) sent from CPU1. This result data is in inFIF01. The third lookup (Im_lut) is performed during clock cycle 1 of CPU2 (or global cycle 6).

It will be appreciated that inFIFO1 of CPU2 is empty until clock cycle 4. The no-operations (nops) are enforced by the FIFO of CPU2 by stalling until the data arrives in the FIFO. It will also be appreciated that. clock cycle 7 (global clock 12) has the same instruction as in the prologue (global clock 5). Therefore, CPU2 begins its loop in clock cycle 1 (global cycle 6).

CPU2 completes the third lookup (cycle 1) and the results of the lookup are placed in R2 of CPU2. It will be understood that the code is written for three lookups and three lookups are, in fact, performed. Since each Im_lut instruction is idempotent, the same result may be looked up three times, without changing the value of the result in R2. For example, the last two lookups may change nothing, if the first lookup is a completely decoded word.

The result of the third lookup stored in R2 of CPU2 is moved out by way of outFIF03 to CPU3 during clock cycle 5 (global cycle 10).

CPU2 also performs a test for an end-of-block (EOB) in clock cycle 3. Pound (#) EOB is all zeroes except for one bit in bit position 29, as shown in FIG. 5C. If this bit is set, then EOB has been looked up. The EOB arrives in CPU1, as a result of CPU2 moving R3 into outFIFO1 during clock cycle 4 (global cycle 9).

If R2 does not equal #EOB, then the branch instruction (bne) during clock cycle 6 (global cycle 11) branches back to the top of the loop. CPU2 is then ready for the next lookup.

Result in R2 of the third lookup (clock cycle 5, global cycle 10) is placed in outFIFO3 (a tag destined for CPU3). Two cycles later, R2 arrives in CPU3 (prologue of CPU3, global cycle 12).

Referring now to the code executed by CPU3, R2 is received by CPU3, during the prologue (global cycle 12) and placed in R2 of CPU3. The job of CPU3 is to forward the result of the lookup to another CPU (for example CPU4) and to test for escape code. R2 is masked and the masked version is placed in R4 of CPU3 (clock cycle 1, global cycle 13).

The instruction in clock cycle 2 performs a comparison between R4 and #ESC (all bits are zero except for one bit in bit position 30, as shown in FIG. 5C).

It will be appreciated that the MPEG standard requires that, after a VLD discovers an escape code (the escape code itself is 6-bits), 18-bits should immediately follow. Consequently, the VLD dumps the 6-bits of the escape code and shifts the bitstream by 18-bits. In addition, any result that is forwarded by CPU3 has the bottom 6 bits of the code thrown away (code length in FIG. 5C is 6-bits).

From the above, the shift instruction during clock cycle 4 (global clock 16) takes the raw bits from CPU1 (in the funnel shift register) and shifts them to the right by 6-bits. In this manner, the code length (6-bits) is thrown away. The shifted result is placed in R3. After the branch instruction (be) (clock cycle 3), the data in R3 is moved out to CPU4 by way of outFIFO4 (clock cycle 5e).

If an ESC is not found, the result of the third lookup, which has been masked and stored in R4 (clock cycle 1), is shifted to the right (srl) by 6-bits and moved out to CPU4, by way of outFIFO4 (alternate instruction in clock cycle 5; global cycle 17).

In summary, by adding an idempotent local memory lookup instruction, the invention is able to implement a 7-clock cycle Huffman decoder by using three CPUs. Again, the Im_lut instruction is a general purpose instruction and Huffman decoding is just one application for that instruction. One LM, as another example, may hold two 6-bit LUTs. By breaking larger lookups into pieces of 6 bits or less, therefore, arbitrary lookups may be achieved at reasonably fast rates simply by changing the software.

The following applications are being filed on the same day as this application (each having the same inventors):

CHIP MULTIPROCESSOR FOR MEDIA APPLICATIONS; VECTOR INSTRUCTIONS COMPOSED FROM SCALAR INSTRUCTIONS; VIRTUAL DOUBLE WIDTH ACCUMULATORS FOR VECTOR PROCESSING; CPU DATAPATHS AND LOCAL MEMORY THAT EXECUTES EITHER VECTOR OR SUPERSCALAR INSTRUCTIONS.

The disclosures in these applications are incorporated herein by reference in their entirety.

Although illustrated and described herein with reference to certain specific embodiments, the present invention is nevertheless not intended to be limited to the details shown. Rather, various modifications may be made in the details within the scope and range of equivalents of the claims and without departing from the spirit of the invention.

What is claimed:

1. In a processor system configured to execute instructions, a method of finding an entry in at least one table stored in memory, the method comprising the steps of:
(a) storing a first table of multiple entries, each entry including a bit field;
(b) storing (i) a first entry of the first table and (ii) a bit size of each entry;
(c) storing a sequence of data bits;
(d) selecting a portion of the sequence of data bits to produce a data field having a bit size same as the bit size of each entry in the first table; and
(e) adding the first entry of the first table to the produced data field to find the entry in the first table.

2. The method of claim 1 wherein step (b) includes storing the first entry of the first table and the bit size of each entry in a first register to produce an operand in memory.

3. The method of claim 2 wherein step (c) includes storing the sequence of data bits in a second register to produce another operand in memory.

4. The method of claim 3 wherein step (a) includes storing each entry of the first table in a respective data register, in which the respective data registers are different from the first and second registers.

5. The method of claim 1 wherein, after step (d) and before step (e), the method includes the following step:
(f) shifting the data field produced in step (d) and masking a remaining sequence of the data bits; and
step (e) includes adding the first entry of the first table to the shifted data field to find the entry in the first table.

6. The method of claim 1 including the steps of:
(f) finding the entry in the first table; and
(g) fetching from the first table a result corresponding to the found entry and storing the result in a destination register.

7. The method of claim 1 wherein
step (a) includes storing a second table of multiple entries, each entry including a second bit field;
the method further including the steps of:
(f) storing (i) a first entry of the second table and (ii) a bit size of each entry in the second table;
(g) selecting a second portion of the sequence of data bits to produce a second data field having a second bit size the same as the bit size of each entry in the second table; and
(h) adding the first entry of the second table to the selected second data field to find the entry in the second table.

8. The method of claim 7 including the steps of:
(i) if the first table includes a desired result, setting a flag in memory;
(j) finding the entry in the first table;
(k) fetching from the first table the desired result corresponding to the found entry in the first table, and storing the desired result in a destination register; and
(l) preserving the desired result in the destination register, after performing an instruction for a look up in the second table.

9. The method of claim 8 wherein step (i) includes storing the first entry of the first table, the bit size of each entry and the flag in a register to produce an operand in memory.

10. The method of claim 7 including the steps of:
(i) if the second table includes a desired result, setting a flag in memory;
(j) finding the entry in the first table, and fetching from the first table an intermediate result corresponding to the found entry in the first table and storing the intermediate result in a destination register;
(k) finding the entry in the second table; and
(1) fetching from the second table the desired result corresponding to the found entry in the second table and replacing the intermediate result stored in the destination register with the desired result.

11. The method of claim 10 wherein step (i) includes storing the first entry of the second table, the bit size of each entry and the flag in a register to produce an operand in memory.

12. In a processor system configured to execute instructions, a method for decoding a portion of a stream of bits comprising the steps of:
(a) receiving a stream of bits;
(b) storing at least one table having multiple entries, each entry including a bit field and a corresponding result;
(c) storing (i) a first entry of the table and (ii) a bit size of each entry;
(d) selecting a portion of the received stream of bits to produce a data field having a bit size the same as the bit size of each entry in the table;
(e) adding the first entry of the table to the produced data field to find the entry in the table;
(f) finding the entry in the table;
(g) fetching from the table a result corresponding to the entry found in step (f); and
(h) if the result is a decoded word of the selected portion of the received stream of bits, then storing the decoded word in a destination register.

13. The method of claim 12 wherein step (a) includes receiving a bit stream of image data, and
step (h) includes storing the decoded word as a code length representing a run, an amplitude and a sign.

14. The method of claim 12 wherein
step (h) includes setting a flag to indicate that the result is the decoded word; and the method further includes the steps of:
(i) storing the flag, the first entry of the table and the bit size of each entry in a register to produce a first operand, accessed by a computer instruction;
(j) storing the data field in another register to produce a second operand, accessed by the same computer instruction; and
(k) using the same computer instruction to store the decoded word as a destination operand in the destination register.

15. The method of claim 14 wherein the computer instruction has a syntax of:
Memory Look Up Table first operand second operand destination operand.

16. The method of claim 14 wherein steps (i) and (j) stores the first and second operand in an internal register file of the processor system; and
step (a) stores the table in a level one memory file, accessible by the same computer instruction.

17. A computer instruction for accessing a look-up-table (LUT), each LUT including an entry word defining a location in the LUT, and a result word corresponding to the entry word, the computer instruction comprising
an opcode for instructing a processor to access an entry word in an LUT,
a first operand for use by the opcode, the first operand including a first entry word in the LUT,
a second operand for use by the opcode, the second operand including an entry word located in the LUT,
a destination operand for use by the opcode for storing a result word,
wherein, in response to the opcode, the processor is configured to add the first entry word of the first operand and the entry word of the second operand to locate the entry word in the LUT, and
the processor is configured to fetch the result word corresponding to the located entry word and store the result word in memory.

18. The computer instruction of claim 17 wherein the first operand includes a bit size of the entry word in the LUT, and the second operand includes an entry word having the same bit size, and
the processor is configured to shift and mask the entry word in the second operand, and then add the first entry word of the first operand to the entry word of the second operand to locate the entry word in the LUT.

19. The computer instruction of claim 17 wherein each result corresponding to an entry word of the LUT is located in a different register in memory,
the first operand and second operand are located in separate internal registers of the processor, and
the processor is configured to add the first entry word in the first operand and the entry word in the second operand to obtain an address of a register in memory containing a result of a corresponding entry word.

20. The computer instruction of claim 17 wherein the processor is configured to concurrently access the first operand, the second operand and the destination operand in one clock cycle.
